(19) United States
(12) Patent Application Publication
(10) Pub. No.: US 2022/0161500 A1
(43) Pub. Date: May 26, 2022

(54) METHOD OF PREVENTING FLUID COLLECTION / SUCTION IN ADDITIVE MANUFACTURING OF 3D OBJECTS

(71) Applicants: DENTSPLY SIRONA Inc., York, PA (US); SIRONA DENTAL SYSTEMS GMBH, Bensheim (DE)

(72) Inventors: Christian STAHL, Darmstadt (DE); Daniel WEISS, Heddesheim (DE)

(73) Assignee: DENTSPLY SIRONA Inc., York, PA (US)

(21) Appl. No.: 17/442,681

(22) PCT Filed: Apr. 8, 2020
(86) PCT No.: PCT/EP2020/059993

§ 371 Date: Sep. 24, 2021

(30) Foreign Application Priority Data
Apr. 9, 2019 (EP) 19020275.4

(51) Int. Cl. B29C 64/393; B29C 64/124; B29C 64/245; B29C 64/232; B29C 64/35; B33Y 40/20; B33Y 80/00; B33Y 50/02; B33Y 10/00

(52) U.S. Cl. CPC B29C 64/393; B29C 64/124; B29C 64/245; B29C 64/232; B29L 2031/753; B33Y 40/20; B33Y 80/00; B33Y 50/02; B33Y 10/00; B29C 64/35

(57) ABSTRACT

The present invention relates to a method of preparing a digital 3D model suitable to be generated and post-processed with an additive manufacturing system (1) comprising: an additive manufacturing apparatus (2) for generating the 3D object (3) corresponding to the prepared digital 3D model, attached to a platform (4) which can be gradually moved upwards, out of a fluid resin (5a) in a vat (6); and at least one post-processing apparatus (7) for performing at least one of washing, drying and curing the 3D object (3) received and maintained in the state attached to the platform (4) during the post-processing, the method comprising: a step of providing the digital 3D model; the method being characterized by further comprising: a step of determining fluid-collecting, basin-like, open regions (8) or fluid-sucking, dome-like, open regions (9) of the digital 3D model orientated in said state relative to the platform (4), and a step of including at least one drain channel (10) and/or at least one vent channel (11) into the fluid-collecting, basin-like, open region (8) and/or the fluid-sucking, dome-like, open region (9) in the digital 3D model respectively for preventing collection of fluid (5a, 5b) or suction of fluid (5a, 5b) during the generation process and the post-processing process.

### TECHNICAL FIELD OF THE INVENTION

The present invention relates to a method of preparing a digital 3D model suitable to be generated and post-processed with an additive manufacturing system having an additive manufacturing apparatus and a post-processing apparatus. The present invention more particularly relates to a method of preparing a digital 3D model in which fluid collection or fluid suction can be prevented during the generation and the post-processing.

### BACKGROUND ART OF THE INVENTION

In additive manufacturing, a three-dimensional object is printed layer-by-layer through light-based curing of a liquid printing medium i.e., a liquid photocurable resin, which is selectively cured under the influence of UV radiation. In commonly known variations of additive manufacturing such as SL (Stereolithography) or DLP (Digital Light Processing), the 3D objects are preferably pulled upside-down from the liquid printing medium by means of a platform. Depending on the geometry of the 3D object, puddles of uncured liquid resin may remain in the fluid-collecting, basin-like, open regions of the 3D object.

In the prior art, the printed 3D objects are manually released from the platform immediately after printing, and the puddles are emptied manually before treatment, for example through turning the 3D object over.

In contrast thereto, in the additive manufacturing solution of the present applicant as disclosed in Appl. No. EP19160123.6, the 3D object is not removed from the platform directly after the printing but is transferred attached to the platform by means of a transport container, without changing its vertical orientation into a post-processing apparatus where it is washed, dried and post-cured. When the liquid resin puddles are formed on the 3D object then the liquid resin contained in these puddles is further introduced into the washing tank of the post-processing apparatus. Thereby, the lifetime of the washing medium, such as isopropyl alcohol, is significantly reduced. In addition, the same puddles that were filled with liquid resin during printing are filled with the liquid washing medium after the washing, and thus the liquid washing medium must be completely evaporated when drying the printed 3D object. As a result, the treatment time required for the drying may increase considerably.

Hence, the fluid-collecting, basin-like, open regions of the 3D objects cause a problem not only during the generation but also during the post-processing. Depending on the geometry of the 3D object, uncured liquid resin or liquid washing medium may also be pulled up into fluid-sucking, dome-like, open regions of the 3D object, and thus the fluid-sucking, dome-like, open regions also cause a problem during the generation and the post-processing, respectively.

EP0757621B1 discloses a method of providing a three-dimensional object to be built layer-by-layer through selective solidification of a solidifiable medium wherein the evacuation of unsolidified medium from a hollow atmospherically closed region is enabled through further including a vent hole and a drain hole into the three-dimensional object.

### DISCLOSURE OF THE INVENTION

An objective of the present invention is to overcome the disadvantages of the prior art and to provide a method of preparing a digital 3D model suitable to be generated and post-processed without being turned over in an additive manufacturing system having an additive manufacturing apparatus and a post-processing apparatus in the context of the present applicant's additive manufacturing solution.

This objective has been achieved by the method as defined in claim 1. The subject-matters of the dependent claims relate to further developments.

The present invention provides a method of preparing a digital 3D model that is suitable to be generated and post-processed with an additive manufacturing system comprising: an additive manufacturing apparatus for generating the 3D object corresponding to the prepared digital 3D model, attached to a platform which can be gradually moved upwards, out of a fluid resin in a vat; and at least one post-processing apparatus for performing at least one of washing, drying and curing the 3D object received and maintained in the state attached to the platform, during the post-processing. The method comprises: a step of providing the digital 3D model; a step of determining fluid-collecting, basin-like, open regions and fluid-sucking, dome-like open regions of the digital 3D model orientated in the said state relative to the platform, and a step of including at least one drain channel and at least one vent channel into the fluid-collecting, basin-like open region and the fluid-sucking, dome-like, open region in the digital 3D model respectively for preventing collection of fluid or suction of fluid during the generation process and the post-processing process.

A major advantageous effect of the present invention is that the fluid i.e., the liquid photocurable resin or the liquid washing medium collected in the basin-like, open region are immediately emptied via the drain channels under the action of gravity during the printing process and the washing process without the need of turning the 3D object over, and thus the user can be prevented from getting into physical contact with the fluids. Thereby, also unnecessary wasting of the fluids can be prevented. Furthermore, the drying time, and thus the overall manufacturing time can be reduced. Hence, the production costs can be reduced. Another major advantageous effect of the present invention is that the fluid sucked in the dome-like, opens region can be immediately emptied through the removal of the negative pressure via the vent channels under the action of atmospheric pressure during the printing process and the washing process. Thereby, the mechanical effects of the fluids on the additive manufacturing system such as torque, suction forces, weight can be prevented. Thereby, the movable parts of the additive manufacturing system can be operated more smoothly and forces acting on the fragile printed parts can be reduced.

According to the present invention, the user may be allowed to manually select and input on a display of the digital 3D model the locations of the inlets and/or outlets of the drain channels respectively to be included into the digital 3D model. However, the method is not limited to the manual selection. According to the present invention, the lowest point in the fluid-collecting, basin-like, open region of the digital 3D model may be automatically found i.e., through the algorithm of a computer-program and set as the location of the inlet of the drain channel. In addition, the user may be allowed to manually select and input on the display the location of the corresponding outlet of the drain channel to be included into the digital 3D model. Alternatively, the manual selection and input of the corresponding outlet may be also omitted and found automatically at a location lying lower than the corresponding inlet of the drain channel through the algorithm of the computer-program.

The algorithm for including the drain channels in the method of the present invention can also be used for the inclusion of the vent channels through a rotation of the digital 3D model by 180 degrees. According to the present invention the user may be allowed to manually select and input on the display of the digital 3D model the locations of the inlets and/or outlets of the vent channels respectively to be included into the digital 3D model. However, since the method is not limited to the manual selection, the highest point in the fluid-sucking, dome-like, open region of the digital 3D model may be automatically found and set as the location of the outlet of the vent channel by means of the software algorithm. In addition, the user may be allowed to manually select and input on the display the location of the corresponding inlet of the vent channel to be included into the digital 3D model. Alternatively, the manual selection and input of the corresponding inlet may be also omitted and found automatically at a location lying higher than the corresponding outlet of the vent channel by means of the software algorithm.

According to the present invention, the inlets and outlets of drain channels as well as the inlets and outlets of the vent channels may be found based on one or more criteria including that the inclination of the drain/vent channel is maximized, and/or the length of the drain/vent channel is minimized. The drain/vent channels may have any shape in order to remain entirely within the digital 3D model. For instance, the drain/vent channels may have one or more segments being straight and/or one or more segments which are curved, and the cross section may be constant or non-constant.

According to the present invention, the surface areas of the digital 3D model where the locations of the inlets and/or outlets of the drain channels and/or vent channels may be found may be restricted. In addition, the volume of the digital 3D model where the drain channels and/or vent channels may pass through may also be restricted. Alternatively, in a complimentary manner, the surface areas of the digital 3D model where the locations of the inlets and/or outlets of the drain channels and/or vent channels must not be found may be restricted. In addition, the volume of the digital 3D model where the drain channels and/or vent channels must not pass through may also be restricted. In case of these restrictions, the above mentioned lowest/highest points are found under consideration of the restricted surface areas and the restricted volumes. Thereby, critical surface areas or critical sub volumes of the digital 3D model can be prevented from including drain/vent channels. However, the method is not limited to an automatic restriction. According to the present invention, the user may be allowed to selectively mark on the display of the digital 3D model the restricted surfaces and/or the restricted volumes.

The method of the present invention may be applied to prepare any 3D object for additive manufacturing. Preferably, the method of the present invention is applied to 3D objects used for dental treatment, for instance dental appliances and dental restorations.

According to the present invention, the method may be provided in form of a computer-program comprising suitable software algorithms and codes for execution of the steps thereof. The computer-program may be provided separately or together with the additive manufacturing system. The codes of the computer-program may be stored in a computer-readable storage means. The storage means may be provided separately from or together with the additive manufacturing system.

### BRIEF DESCRIPTION OF THE DRAWINGS

In the subsequent description, further aspects and advantageous effects of the present invention will be described in more detail by using exemplary embodiments and by referring to the drawings, wherein

FIG. 1—is a partial schematic cross-sectional view of an additive manufacturing apparatus which generates a 3D object having a drain channel, corresponding to the digital 3D model prepared through the method according to an embodiment of the present invention;

FIG. 2—is a partial schematic cross-sectional view of an additive manufacturing apparatus which generates a 3D object having a vent channel, corresponding to the digital 3D model prepared through the method according to an embodiment of the present invention;

FIG. 3—is a schematic cross-sectional view of an additive manufacturing system for generating and post-processing of the 3D object having a drain channel, corresponding to the digital 3D model prepared through the method according to an embodiment of the present invention.

The reference numbers shown in the drawings denote the elements as listed below and will be referred to in the subsequent description of the exemplary embodiments:
1. Additive manufacturing system
2. Additive manufacturing apparatus
3. 3D object
4. Platform
5. Fluid
   5a. Liquid photocurable resin
   5b. Liquid washing medium (e.g. Isopropyl alcohol)
6. Vat
7. Post-processing apparatus
8. Basin-like open region
9. Dome-like open region
10. Drain channel
11. Vent channel
12. Inlet
13. Outlet
14. Dental appliance

FIG. 3 shows an additive manufacturing system (1) which has an additive manufacturing apparatus (2) for generating (printing) a 3D object (3) that corresponds to a previously prepared digital 3D model, wherein the 3D object (3) is attached to a platform (4) that can be gradually moved upwards, out of a liquid photocurable resin (5a) in a vat (6). The additive manufacturing system (1) also has a post-processing apparatus (7) for performing at least one of washing, drying and curing the 3D object (3) received and maintained in the state attached to the platform (4) during the post-processing. After the 3D object (3) is generated through the manufacturing apparatus (2) it is transferred on the platform (4) by means of a transport container (not shown), without changing its vertical orientation into the post-processing apparatus (7).

The present invention provides a method of preparing the digital 3D model to be generated and post-processed with the additive manufacturing system (1).

In alternative embodiments, the method is implemented through a computer-program (not shown) that provides input to the additive manufacturing system (1). The computer-program may include user-selectable or preset modes including a manual mode, an automatic mode and/or a semi-automatic mode for preparing the digital 3D model as will be described in more detail in the following.

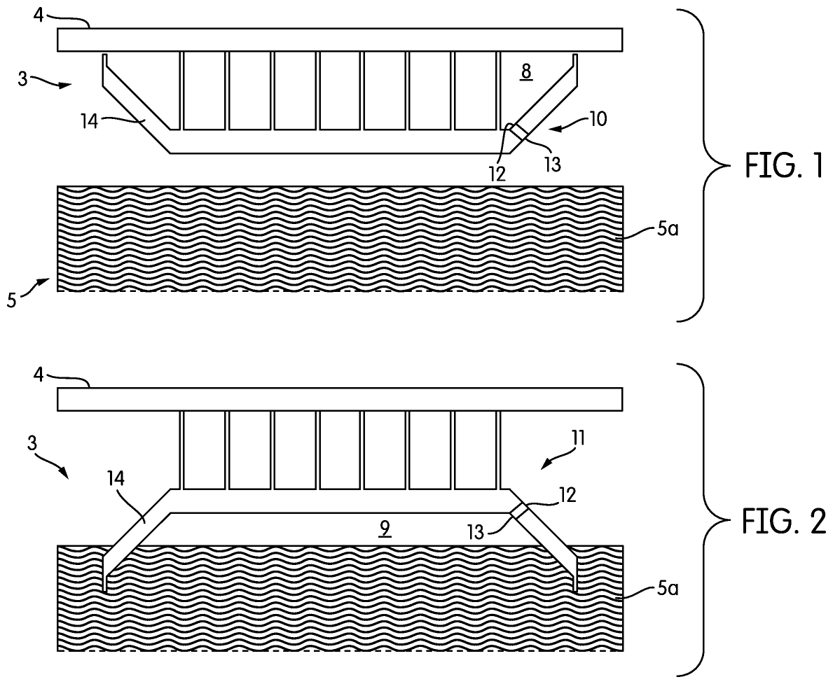

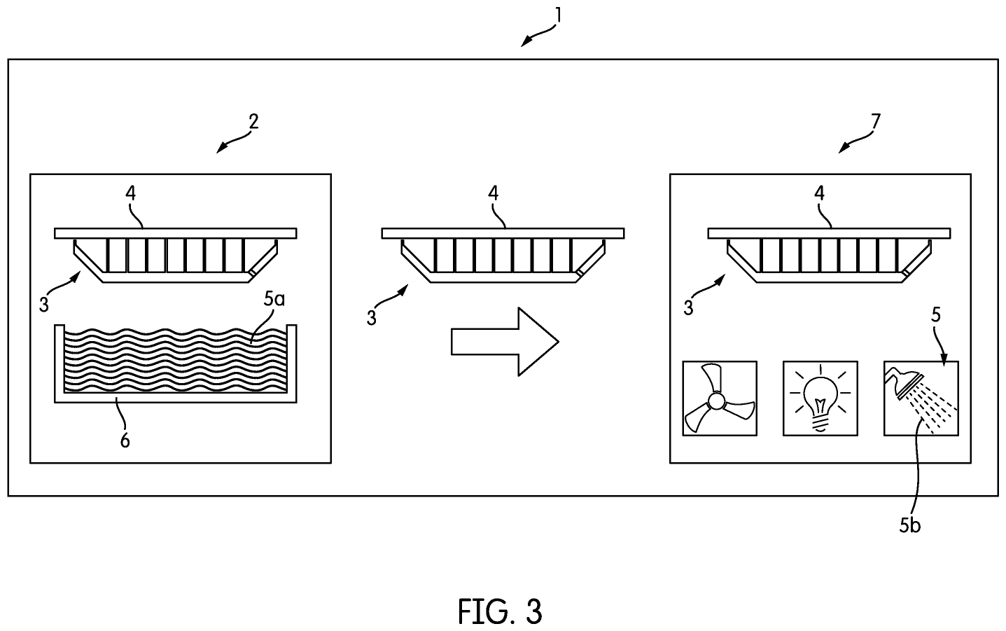

In an initial step, the digital 3D model to be overworked is provided in a desired printing orientation relative the platform (4). In a next step, the fluid-collecting, basin-like, open regions (8) and the fluid-sucking, dome-like, open regions (9) of the digital 3D model are determined when the digital 3D model is orientated in the above-mentioned attached state relative to the platform (4) i.e., in the printing state which defines the desired printing orientation of the 3D model relative the platform (4). In FIG. 1 and FIG. 2, two different 3D objects (3) have been illustrated, wherein the former one has at least one fluid-collecting, basin-like, open region (8) whereas the latter one has at least one fluid-sucking, dome-like, open region (9). In a next step of the method, at least one drain channel (10) is included into the fluid-collecting, basin-like, open region (8) in the digital 3D model as shown in FIG. 1 for preventing collection of fluid (5; 5a, 5b) during the generation process and the post-processing process. For the sake of simplicity only one drain channel (10) has been illustrated. Similarly, as shown in FIG. 2, at least one vent channel (11) is included into the fluid-sucking, dome-like, open region (9) in the digital 3D model for preventing suction of fluid (5; 5a,5b) during the generation process and the post-processing process.

In another embodiment, the digital 3D model is displayed to a user on a display (not shown). The user can perform the determination step and the inclusion step manually on the display. Alternatively, these steps may be performed automatically or semi-automatically through algorithms of the computer-program.

In another embodiment, the user can manually select and input on the display the locations of the inlets (12) and/or outlets (13) of the drain channels (10), respectively, to be included into the digital 3D model. The path of the drain channels (10) within the digital 3D object (3) may be manually defined on the display by the user or automatically calculated.

In another embodiment, the lowest point in the fluid-collecting, basin-like, open region (8) of the digital 3D model can be automatically found and set as the location of the inlet (12) of the drain channel (10). In addition, the user can manually select and input on the display the location of the corresponding outlet (13) of the drain channel (10) to be included into the digital 3D model.

In another embodiment, the outlet (13) for the drain channel (10) can also be automatically found at a location lying lower than the corresponding inlet (12) of the drain channel (10).

In another embodiment, one or more outlets (13) for the drain channels (10) are automatically found based on one or more criteria including that the inclination of the drain channel (10) is maximized and/or the length of the drain channel (10) is minimized such that the drain channel (10) remains entirely within the digital 3D model.

In another embodiment, the user can manually select and input on the display the locations of the inlets (12) and/or outlets (13) of the vent channels (11) respectively to be included into the digital 3D model. The path of the vent channels (11) within the digital 3D object (3) may be manually defined on the display by the user or automatically calculated.

In another embodiment, the highest point in the fluid-sucking, dome-like, open region (9) of the digital 3D model can be automatically found and set as the location of the outlet (13) of the vent channel (11). In addition, the user can manually select and input on the display the location of the corresponding inlet (12) of the vent channel (11) to be included into the digital 3D model.

In another embodiment, the inlet (12) for the vent channel (11) can also be automatically found at a location lying higher than the corresponding outlet (13) of the vent channel (11).

In another embodiment, one or more inlets (12) for the vent channels (11) are automatically found based on one or more criteria including that the inclination of the vent channel (11) is maximized and/or the length of the vent channel (11) is minimized such that the vent channel (11) remains entirely within the digital 3D object (3).

In other alternative embodiments, the drain channels (10) or the vent channels (11) have one or more straight segments and/or one or more curved segments with constant or non-constant cross section.

In another embodiment, it is possible to restrict the surface areas of the digital 3D model where the locations of the inlets (12) and/or outlets (13) of the drain channels (10) and/or vent channels (11) may be found. In addition, it is also possible to restrict the volume of the digital 3D model where the drain channels (10) and/or vent channels (11) may pass through.

In another alternative embodiment, it is possible to restrict the surface areas of the digital 3D model where the locations of the inlets (12) and/or outlets (13) of the drain channels (10) and/or vent channels (11) must not be found. Similarly, it is also possible to restrict the volume of the digital 3D model where the drain channels (10) and/or vent channels (11) must not pass through. In case the above-mentioned restrictions are imposed, the lowest/highest points are found under consideration of these restrictions.

In another embodiment, the user is allowed to selectively mark on the display of the digital 3D model the restricted surface areas and/or the restricted volumes. Alternatively, the surface area and/or the volume are automatically restricted in accordance with predetermined conditions. Such conditions may relate, for instance to the mechanical stability, proper operation or the visual appearance of the 3D object.

In another embodiment, the digital 3D object (3) corresponds to a dental appliance (14).

1. A method of preparing a digital 3D model suitable to be generated and post-processed with an additive manufacturing system comprising: an additive manufacturing apparatus for generating the 3D object corresponding to the prepared digital 3D model, attached to a platform which can be gradually moved upwards, out of a liquid photocurable resin in a vat; and at least one post-processing apparatus for performing at least one of washing, drying and curing the 3D object received and maintained in the state attached to the platform during the post-processing, the method comprising:
a step of providing the digital 3D model in a desired printing orientation relative the platform;
the method further comprising:
a step of determining fluid-collecting, basin-like, open regions and fluid-sucking, dome-like, open regions of the digital 3D model for the desired printing orientation relative to the platform, and
a step of including at least one drain channel and at least one vent channel into the fluid-collecting, basin-like, open region and the fluid-sucking, dome-like, open region in the digital 3D model respectively for the purpose of preventing collection of fluid and suction of fluid respectively during the generation process and the post-processing process.

2. The method according to claim 1, further comprising:
a step of displaying the digital 3D model to a user on a display; and
a step of allowing the user to manually select and input on the display the locations of the inlets and/or outlets of the drain channels and/or the vent channels respectively to be included into the digital 3D model.

3. The method according to claim 2, further comprising:
a step of finding the lowest point in the fluid-collecting, basin-like, open region of the digital 3D model and setting the lowest point as the location of the inlet of the drain channel; and
a step of allowing the user to manually select and input on the display the location of the corresponding outlet of the drain channel to be included into the digital 3D model.

4. The method according to claim 3, further comprising:
a step of finding at least one outlet for the drain channel at a location lying lower than the corresponding inlet of the drain channel, wherein the corresponding manual selection and input is omitted.

5. The method according to claim 4, wherein one or more outlets for the drain channel are found based on one or more criteria including that the inclination of the drain channel is maximized and/or the length of the drain channel is minimized, wherein the drain channel remains entirely within the digital 3D object.

6. The method according to claim 2, further comprising:
a step of finding the highest point in the fluid-sucking, dome-like, open region of the digital 3D model and setting the highest point as the location of the outlet of the vent channel; and
a step of allowing the user to manually select and input on the display the location of the corresponding inlet of the vent channel to be included into the digital 3D model.

7. The method according to claim 6, further comprising:
a step of finding at least one inlet for the vent channel at a location lying higher than the corresponding outlet of the vent channel, wherein the corresponding manual selection and input is omitted.

8. The method according to claim 7, wherein one or more inlets for the vent channel are found based on one or more criteria including that the inclination of the vent channel is maximized and/or the length of the vent channel is minimized, wherein the vent channel remains entirely within the digital 3D object.

9. The method according to claim 2, comprising:
a step of restricting the surface areas of the digital 3D model where the locations of the inlets and/or outlets of the drain channels and/or vent channels may be found, and/or to restrict the volume of the digital 3D model where the drain channels and/or vent channels may pass through, wherein the lowest/highest points are found under consideration of the restriction.

10. The method according to claim 2, comprising:
a step of restricting the surface areas of the digital 3D model where the locations of the inlets and/or outlets of the drain channels and/or vent channels must not be found, and/or to restrict the volume of the digital 3D model where the drain channels and/or vent channels must not pass through, wherein the lowest/highest points are found under consideration of the restriction.

11. The method according to claim 9, comprising
a step of allowing the user to selectively mark on the display of the digital 3D model the restricted surface areas and/or the restricted volumes.

12. The method according to claim 1, wherein the drain channels or the vent channels have one or more segments being straight or one or more segments being curvilinear where the straight or curvilinear segments have constant or non-constant cross section.

13. The method according to claim 1, wherein the digital 3D object corresponds to a dental appliance.

14. A computer-program product comprising one or more computer-readable storage devices, and program instructions stored on at least one of the one or more storage devices, the stored program infractions comprising instructions to perform the method of claim 1.

15. A non-transitory computer-readable storage medium storing a program, which when executed by a computer system causes the computer system to perform a procedure comprising the method according to claim 1.

16. The method according to claim 10, further comprising
a step of allowing the user to selectively mark on the display of the digital 3D model the restricted surface areas and or the restricted volumes.
